(19) United States
(12) Patent Application Publication
(10) Pub. No.: US 2011/0245106 A1
(43) Pub. Date: Oct. 6, 2011

(54) Sample Carrier and Method for Achieving Comparable Analytical Results By Aligning Test Substances on a Uniform Plane

(75) Inventors: Andreas FISCHER, Huertgenwald (DE); Dagmar Lischke, Inden (DE); Dagmar Peters-Groth, Aachen (DE)

(73) Assignee: Gruenenthal GmbH, Aachen (DE)

(21) Appl. No.: 13/099,916

(22) Filed: May 3, 2011

Related U.S. Application Data
(63) Continuation of application No. PCT/EP2009/007914, filed on Nov. 5, 2009.

(30) Foreign Application Priority Data
Nov. 6, 2008 (EP) 08019415.2

(51) Int. Cl. C40B 30/10; C40B 60/12

(52) U.S. Cl. 506/12; 506/39

(57) ABSTRACT

A sample carrier such as a multi-well platform with one or more recesses, in each of which a substance to be analyzed is disposed, and an analysis method in which one or more substances, each of which is located in a recess of the sample carrier, are aligned on a uniform plane relative to the surface of the sample carrier before being analyzed.

### CROSS REFERENCE TO RELATED APPLICATIONS

This application is a continuation of international patent application no. PCT/EP2009/007914, filed Nov. 5, 2009, designating the United States of America and published in German on May 14, 2010 as WO 2010/051990 A1, the entire disclosure of which is incorporated herein by reference. Priority is claimed based on European patent application no. EP 08019415.2, filed Nov. 6, 2008, which likewise is incorporated herein by reference in its entirety.

### BACKGROUND OF THE INVENTION

The present invention relates to a sample carrier, for example a multi-well platform, with one or a plurality of recesses, in each of which a substance to be analyzed is located. The present invention furthermore relates to a method in which one or more substances, which are each located in a recess of a sample carrier, are aligned on a uniform plane relative to the surface of the sample carrier before being analyzed.

Analyses of substances in high throughput methods make it necessary to carry out reactions and/or analytical measurements in sample carriers having a plurality of recesses, in or on which the respective substance is located. One analysis method in this context is, for example, X-ray powder diffractrometry, which is a standard method when determining polymorphism. In this measurement, an X-ray beam is successively directed onto each substance on the sample carrier and the portion reflected thereby is evaluated. However, the analysis of substances in sample carriers of this type has the drawback that the results achieved thereby can only be compared with one another to a limited extent.

### SUMMARY OF THE INVENTION

It was therefore the object of the present invention to provide a sample carrier with which analyses of substances located on or in the sample carrier can be carried out and which ensures very good comparability of the results achieved.

Another object of the invention was to provide an analysis method with which test substances can be analyzed to obtain analysis results with very good comparability.

These and other objects of the invention are achieved in accordance with the present invention by providing a sample carrier having a plurality of recesses, in each of which a substance to be analyzed is located, said sample carrier having means with which the substances to be analyzed can be aligned on the same plane relative to the sample carrier.

The sample carrier according to the invention is, for example, a so-called multi-well platform. The sample carrier has one or any desired plurality of recesses, in particular holes, which are preferably arranged in a uniform pattern, most preferably equidistantly. The recesses preferably extend through the entire thickness of the sample carrier. The recesses may have any cross-section, but are preferably circular. The recesses are preferably lined with a sleeve, in particular a sleeve to which the adhesion of the substances is as low as possible. For example, this is a Teflon sleeve. In another preferred embodiment each recess is coated, for example with a non-stick coating, and/or the entire sample carrier is made of an inert material, which particularly preferably also has non-stick properties.

In each of these recesses, a vessel is preferably arranged so as to be displaceable along the recess. For example, the vessel may be part of a plunger, in particular arranged on the upper side thereof. The plunger may be produced from glass, metal, in particular steel and/or plastics material. It may also have a non-stick coating. This vessel may be of any configuration. For example, it may be planar but also curved in a convex and/or concave manner. The substance to be analyzed is located, in each case, in the vessel and/or on the vessel. The height of the substance preferably extends at least to the upper edge of the vessel, at least at times but particularly preferably projects from it. The substance to be analyzed may in each case be placed on the vessel. However, the production of the respective substance preferably also takes place in the vessel, for example by reaction and/or a processing operation, so the vessel can also be configured as a production vessel. In this case, the production preferably takes place in a comparatively lowered state of the vessel within the sample carrier. The vessel may be produced from glass, metal, in particular steel, and/or plastics material. It may also have a non-stick coating.

According to the invention, the sample carrier has a means with which the substances to be analyzed can be aligned, in each case, on the same plane, in particular a horizontal plane, preferably above the sample carrier, relative to the surface of the sample carrier. This means is preferably a covering means, which covers one side of each recess. The respective substance is preferably moved, in particular displaced, before being analyzed, along the recess in the direction of the cover, which, for example, can take place using the above-described plunger, which is pressed against the vessel from below. The respective substance to be analyzed may, however, simply be poured into the respective recess; it then drops onto the cover and preferably remains suspended thereon, at least in part.

Thus, each substance and/or the respective vessel comes into contact with the covering means, so these are then all located in the same plane relative to the surface of the sample carrier. Accordingly, in the sample carrier according to the invention, all the substances, at least in partial regions, have the same position in relation to the surface of the sample carrier. The quality of the comparability of the analysis, for example in X-ray powder diffractometry measurement in reflection, is therefore increased.

The covering means preferably serves as a stop for the respective substance and/or the respective vessel. These are preferably pressed against the covering means and, in this case, particularly preferably pressed flat. The covering means is preferably provided in one piece and accordingly covers all the ends of the recesses present on one side of the sample carrier. The transmission of the covering means, in particular in relation to X-ray beams, is particularly preferably as high as possible. The covering means is preferably a film, in particular an X-ray permeable film. A film within the meaning of the invention has a thickness in the pm range. In another preferred embodiment, the covering means is a plate, in particular an X-ray permeable plate, which has a higher mechanical stability than a film, and in particular is not damaged or plastically deformed by the substances and/or the vessels.

A cross-contamination of the substances with one another can also be prevented by the covering means.

A spacer is preferably arranged between the sample carrier and the covering means. The covering means is then preferably arranged on this spacer, in particular reversibly. The covering means, in particular if it is a film, is particularly preferably glued to the spacer. The spacer has recesses, for example in the form of through-holes, which are arranged coaxially with the recesses of the sample carrier. The thickness of this spacer is preferably greater than the amount by which the sleeves arranged in the recesses of the sample carrier project from the surface of the sample carrier. A thickness of a few millimetres is generally sufficient. The area of the recess in the spacer is preferably equal to or greater than the area of the recess located therebelow in the sample carrier. In particular, the area of each recess in the spacer is so great that it can receive the outer edge of the sleeves which are located in the recesses in the sample carrier. As a result, the spacer does not rest on the edge of a sleeve, but directly on the respective surface of the sample carrier. If the substances are now moved precisely up to the outer edge of the spacer, where the covering means is located as a stop, they are all aligned precisely in the same plane relative to the surface of the sample carrier. With a horizontally orientated sample carrier, they are, for example, located precisely at the same height thereabove.

A counter means is preferably arranged on the side of the covering means remote from the sample carrier. This counter means in particular increases the mechanical loading capacity of the covering means and is in particular advantageous when the covering means is a film. The counter means is preferably fastened to the sample carrier in such a way that the covering means is located between the counter means and the sample carrier. The counter means ensures that the substances and/or the vessels do not damage the covering means when they are brought into contact with it. Owing to the counter means, the substances can be pressed against the covering means with a comparatively high force, without the covering means changing its position and/or being mechanically destroyed. The counter means can also serve as a stop for the substances and/or the vessels. For the actual analysis, the counter means is then preferably removed from the sample carrier.

The sample carrier according to the invention is suitable for any analysis, in particular, however, for high throughput screening and, in this case, in particular for analysing reflection measurements by means of X-ray powder diffractometry.

A further subject of the present invention is a method for analysing a plurality of substances which are each located in the recess of a sample carrier, in which the substances are aligned on a uniform plane relative to the sample carrier before being analyzed.

The alignment may take place by a manual or mechanical application of force and/or due to the action of gravity.

The statements made with regard to the sample carrier according to the invention apply equally to the method according to the invention and vice versa. The method according to the invention can be carried out, in particular, with the sample carrier according to the invention.

The recesses are preferably covered with a covering means. This covering means preferably serves as a stop for all the samples and/or the vessel on or in which they are located, but also serves to avoid cross-contamination of the substances with one another.

The substances are preferably made to rest on the covering means, preferably pressed against it.

In a preferred embodiment, the substances to be analyzed are each located in and/or on a vessel which is longitudinally displaceably arranged in a recess of the sample carrier in each case, these vessels being moved, in each case, in the direction of the covering means prior to the analysis of the substances, until the substance and/or the vessel touches the covering means in each case.

### BRIEF DESCRIPTION OF THE DRAWINGS

The invention will be explained in further detail hereinafter with reference to illustrative embodiments depicted in the accompanying FIGS. 1 to 5. These embodiments are merely examples of the invention and do not limit the general concept of the invention. The following explanations apply equally to the apparatus and method of the invention. In the drawings:

FIG. 1 shows a sample carrier, in this case a multi-well platform;

FIG. 2 shows a plunger with a vessel;

FIG. 3 shows a spacer;

FIG. 4 shows the counter plate; and

FIG. 5 shows the sample carrier prior to the measurement.

### DETAILED DESCRIPTION OF PREFERRED EMBODIMENTS

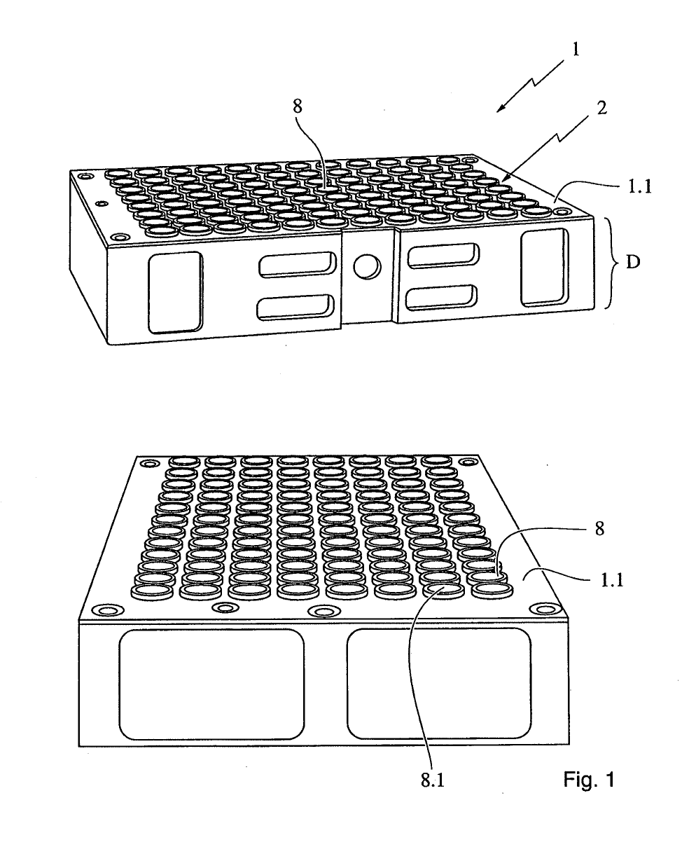

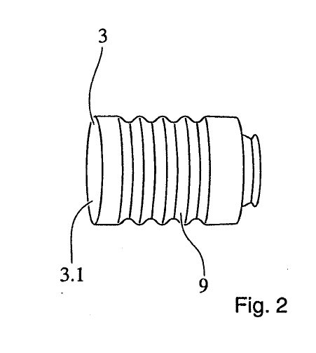

FIG. 1 shows the sample carrier 1 according to the invention in two views. In this case, this is a multi-well plate. It has a plurality of through-holes 2, in this case 96, which thus extend over the entire thickness D of the sample carrier. The holes 2 are equidistantly arranged in a uniform pattern. Each hole is lined with a Teflon sleeve 8, which projects beyond the surface 1.1 of the sample carrier by a specific amount, with this amount varying, but generally not exceeding a maximum of 2 mm. The Teflon sleeve has an external diameter 8.1 at its upper end. A plunger 9, shown in FIG. 2, is arranged in each of these Teflon sleeves 8. The plunger consists of steel and/or Teflon and, at its upper end, has a preferably planar glass plate 3, namely the vessel on which the substance 4 to be analyzed is arranged and/or on which the substance to be analyzed is produced. The diameter of the plunger 9 and the vessel 3 is such that the plunger can be displaced within the sleeve using a moderate application of force.

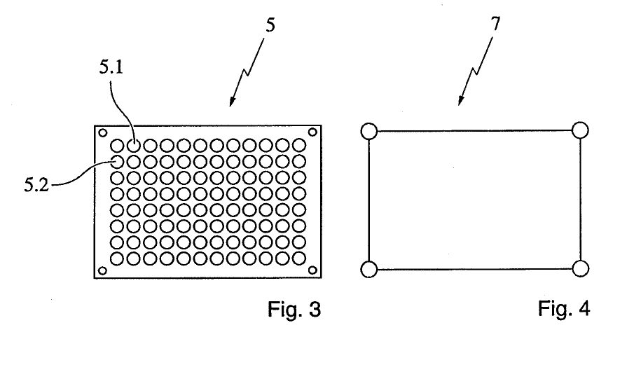

FIG. 3 shows the spacer 5, which also has a plurality of through-holes 5.1, the arrangement of which corresponds to the arrangement of the holes 2 in the sample carrier, so the centre point of the holes 2, 5.1 is flush when the spacer 5 is placed on the sample carrier 1. The diameter 5.2 of the holes 5.1 is selected in such a way that it is at least equal to, preferably slightly greater than, the external diameter of the sleeves 8, so the upper end thereof can be received by the recesses 5.1. The spacer 5 can be connected to the sample carrier by means of four screws in the corner region 5. Once the spacer 5 has been placed on the sample carrier 1, no sleeve edge projects beyond the surface of the spacer.

A covering means 6, in this case a film, preferably an X-ray permeable film, for example the film with the commercial name Ultraphan, is now glued to the spacer 5. A water-soluble adhesive has proven successful as the adhesive. The surface of the spacer 5 is coated with the adhesive, at least in portions, and then the film 6 is glued thereon.

The counter plate 7, which is shown in FIG. 4, is then fastened, for example screwed, onto the spacer to which the film has been glued.

The substances are analyzed as follows. A respective substance 4 is placed on the vessel 3 of a sample carrier or produced therein. The vessels 3 and the plungers 9 are located, in this case, in a comparatively lowered position. Thereafter or beforehand, the spacer 5 to which a film 6 has been glued is fastened to the surface 1.1 of the sample carrier 1. The counter plate is applied thereon. The sample carrier, together with the spacer 5, film 6 and counter plate 7, is then rotated through 180°, so the counter plate points downwards. The plungers 9 and therefore the vessels 3 are then displaced manually or mechanically in the direction of the covering means 6, until the edge 3.1 of the vessels 3 rests in each case on the covering means 6. The counter plate 7 prevents the film 6 being damaged, in particular over-extended, by the vessels 3. The counter plate, however, also serves as a stop for the vessels/plungers, so the edge 3.1 of all the vessels and the position of the substances 4 after the displacement of the plungers have exactly the same position relative to the surface of the sample carrier 1, i.e. the substances 4 and/or the edge 3.1 then all have the same spacing from the surface 1.1 of the sample carrier. The substances 4 may partially adhere to the film 6 in part. Thereafter, the sample carrier is rotated back through 180° and the counter plate 7 is now removed from the sample carrier 1 and the sample carrier is fastened, preferably horizontally, on an analysis instrument and the analysis is carried out substance by substance. The substances all have the same height and this is advantageous for the comparability of the measurements.

The person skilled in the art will understand that the counter plate 7 can be dispensed with if, for example, the covering means itself has such an adequate mechanical stability that it is not damaged or plastically deformed by the substances and/or the vessels.

The plungers/vessels can be omitted if the respective substance to be analyzed adheres to the covering means. In this case, the sample carrier provided with the covering means, as described above, only has to be aligned with the covering means downwardly and the respective substance to be analyzed must only be poured into a hole in each case, which substance then drops onto the covering means and adheres there. The sample carrier can then be rotated back again and the analysis carried out.

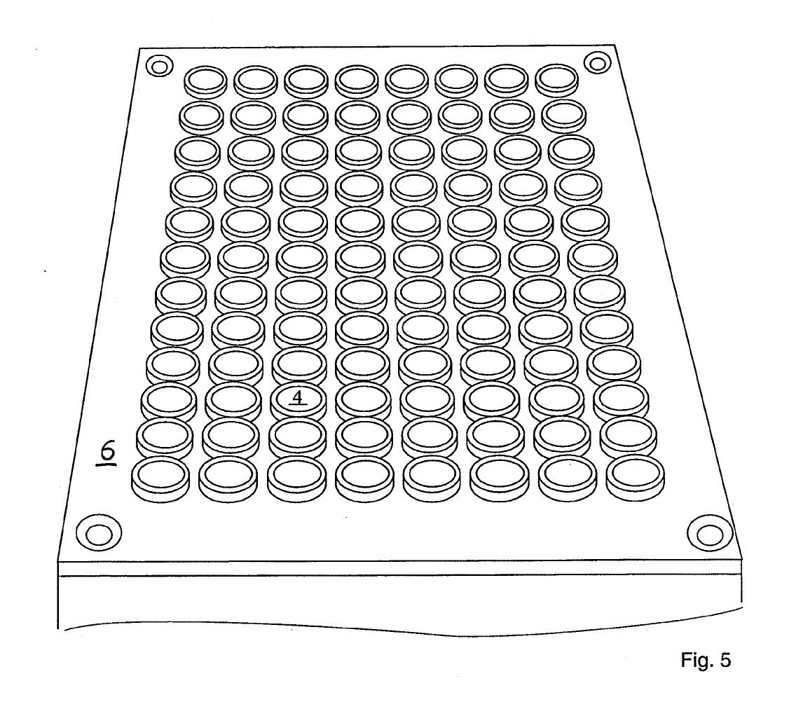

FIG. 5 shows the sample carrier after the alignment. It can clearly be seen how the substances adhere to the film 6, which is glued to the spacer 5. All the substances are located at the same height.

The foregoing description and examples have been set forth merely to illustrate the invention and are not intended to be limiting. Since modifications of the described embodiments incorporating the spirit and substance of the invention may occur to persons skilled in the art, the invention should be construred broadly to include all variations within the scope of the appended claims and equivalents thereof.

### LIST OF REFERENCE NUMERALS

1 sample carrier, multi-well plate, multi-well platform

1.1 surface of the sample carrier

2 recess, hole

3 vessel, reaction vessel, glass plate

3.1 upper edge of the reaction vessel

4 substance to be analyzed

5 spacer, perforated plate

5.1 recesses in the spacer, through-hole

5.2 diameter, area of the recess

6 covering means, cover, film

7 counter means, counter plate

8 lining, sleeve, Teflon sleeve

8.1 area, diameter of the sleeve

9 plunger

D thickness of the sample carrier

1. A sample carrier having a plurality of recesses, in each of which recesses a substance to be analyzed is disposed, wherein said sample carrier is provided with means for aligning the substances to be analyzed at the same height relative to a surface of the sample carrier.

2. A sample carrier according to claim 1, wherein a vessel on which the substance to be analyzed is disposed, is displaceably arranged in each of the recesses.

3. A sample carrier according to claim 1, wherein a covering means, which serves as a stop for the substance to be analyzed, is arranged at least in part on the sample carrier.

4. A sample carrier according to claim 3, wherein a spacer is arranged between the sample carrier and the covering means.

5. A sample carrier according to claim 4, wherein the spacer has recesses which are arranged coaxially with the recesses of the sample carrier.

6. A sample carrier according to claim 5, wherein the recesses in the spacer each have an area which is equal to or greater than that of the respective coaxially arranged recess in the sample carrier.

7. A sample carrier according to claim 5, wherein the recesses in the spacer each have a diameter which is greater than that of the respective coaxially arranged recess in the sample carrier.

8. A sample carrier according to claim 3, wherein said covering means comprises a film.

9. A sample carrier according to claim 8, wherein said film is an X-ray permeable film.

10. A sample carrier according to claim 1, further comprising a counter arranged on the side of the covering means remote from the sample carrier.

11. A method for analyzing a plurality of substances each located in a respective recess of a sample carrier, wherein the substances are aligned on a uniform plane relative to the sample carrier before being analyzed.

12. A method according to claim 11, wherein the recesses are covered by a covering means.

13. A method according to claim 12, wherein the substances are disposed to rest on the covering means.

14. A method according to claim 13, wherein the substances are pressed against the covering means.

15. A method according to claim 12, wherein the substances are each located in or on a vessel which is longitudinally displaceably arranged in a sample carrier, and wherein before analysis of each substance, the respective vessel is moved in the direction of the covering means until the substance or the respective vessel contacts the covering means.
